(19) United States
(12) Patent Application Publication
(10) Pub. No.: US 2015/0305393 A1
(43) Pub. Date: Oct. 29, 2015

(54) BEVERAGE WITH HEART AID FUNCTIONAL INGREDIENTS AND PROCESS THEREOF

(71) Applicant: TATA GLOBAL BEVERAGES LIMITED, Mumbai (IN)

(72) Inventor: Pradeep PODDAR, Mumbai (IN)

(73) Assignee: TATA GLOBAL BEVERAGES LIMITED, Mumbai (IN)

(21) Appl. No.: 14/647,779

(22) PCT Filed: Nov. 27, 2013
(86) PCT No.: PCT/IN2013/000715

§ 371 Date: May 27, 2015

(30) Foreign Application Priority Data
Nov. 27, 2012 (IN) 3386/MUM/2012

(51) Int. Cl. A23L 2/02; A23L 2/58; A23L 2/56; A23L 2/44; A23L 2/60

(52) U.S. Cl. CPC A23L 2/02; A23L 2/44; A23L 2/60; A23L 2/56; A23L 2/58; A23V 2002/00

(57) ABSTRACT

A beverage and the process for manufacturing it form part of this invention. The beverage consists of predetermined ingredients. This ready to consume product shows increased acceptability in individuals suffering from heart ailments, due to the use of specific heart aid ingredients in the constitution of the product. The process of manufacturing the product includes the steps of purification of water, mixing of ingredients, blending, homogenization and pasteurization of the beverage at specific process conditions.

### FIELD OF THE INVENTION

The present invention relates to a ready to drink beverage. Particularly present invention relates to a beverage with heart aid functional ingredients for maintaining a healthy heart and blood circulatory system. The invention also relates to the process of manufacturing the beverage having said heart aid functional ingredients.

### BACKGROUND OF THE INVENTION

Literature is flooded with the aspect of ready to drink beverages. But, the literature on the art fails to serve as a lightning rod for those who prefer to have a ready to drink beverage with heart aid functional ingredients. Even the products which are present in the market do not provide ready to drink heart aid beverage to the patrons. This invention surmounts the demerits of the prior art by providing a synergistic concoction of ingredients in a ready to drink beverage, which helps in pursuing a healthy regime.

KR1020050087605 provides a method of making grape granule tea containing antioxidative anthocyanins and catechins from organic grape juice concentrate and organic grape seed extract by measuring the content of anthocyanins in organic grapes and total catechins and 4 catechin compounds in organic grape seeds and then treating the organic grapes and organic grape seeds is provided. Therefore, the tea contains antioxidative catechin components and anthocyanins in great quantities and thus can be used as an effective component of functional food for preventing cancer, heart disease, hypotension and aging.

WO2007147319 capsule, which is prepared from edible fiber, soybean isoflavone extract of grape seed, optionally vitamin C and vitamin E. The capsule can be taken by the person suffering from heart disease, hypertension or diabetes.

KR100265032 claims within its scope a chewing gum composition which can prevent arteriosclerosis, heart disease, thrombosis and cerebral infarction by containing red wine extract powder, red grape seed extract or a mixture thereof in chewing gum base. EP2031988 provides for a sparkling juice beverage comprising carbonated water, juice concentrate, antioxidants Vitamins C and E, green tea extract and grape seed extract. The beverage may be sweetened with natural sweeteners, artificial sweeteners, or combinations thereof. The sparkling juice beverage of the invention provides a delicious and refreshing way to give the body important antioxidants for body health.

Though the cited arts vouch for the use of grape seed extract in beverages and its use as a healthy heart promoting agent, they fail to provide a composition having synergistic combination of ingredients which assists in maintaining a good heart and health.

The present invention objectifies the prevalent disadvantages and works towards attainment of a flavoured, ready to drink beverage, having heart aid ingredients.

### OBJECT OF THE INVENTION

The object of the present invention is to provide a ready to drink beverage with heart aid functional ingredients for maintaining a healthy heart.

Another object of the present invention is to give the consumer, a taste that is desirable in a beverage, without the effort and cost.

Further object of the present invention is to provide a process of manufacturing the ready to drink beverage comprising of heart aid ingredients.

Yet another object of the present invention is to maintain the shelf life of the claimed product, by employing process steps to preserve the shelf life.

### SUMMARY OF THE INVENTION

In order to achieve the aforesaid objects of the present invention and to obviate the drawbacks of the prior art, the present invention provides a ready to drink beverage, having heart aid ingredients and a process for the manufacture of said beverage. The present invention provides beverage which is ready to drink and is a considerable improvement over the prior art.

The beverage of the present invention comprises treated/processed water, fructose powder, fruit juice/s from concentrate, heart aid ingredients, sweeteners, acidity regulators, flavours, stabilizers/emulsifiers, antioxidant/s, and food colours.

A beverage with heart aid function ingredients as taught by the present invention comprises:
80 to 90% potable water,
2.5 to 6% fructose powder,
0.1 to 15% fruit puree/juices from concentrate,
1 to 6% fruit sweetener,
0.01 to 0.2% grape seed extract,
0.01 to 0.3% fruit flavours,
0.01 to 0.3% acidity regulators,
0.01 to 0.5% stabilizers and emulsifiers,
0.01 to 0.2% antioxidants,
0.001 to 0.02% food colour.

The process of the present invention involves purification of water, mixing of ingredients, blending, homogenization and pasteurization of the beverage at specific process conditions.

### DESCRIPTION OF THE DRAWINGS

FIG. 1 denotes the flow chart of the process for making beverage having heart aid ingredients.

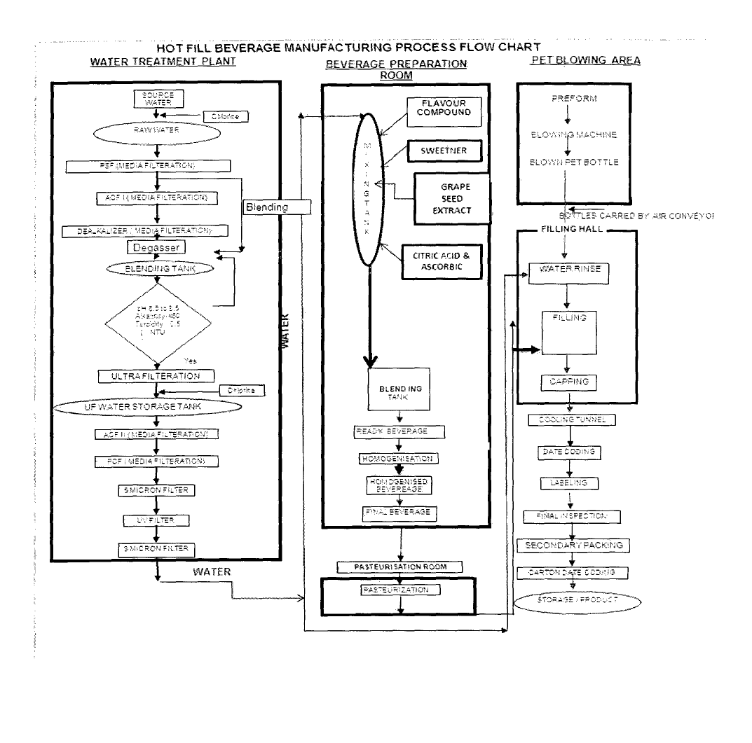

While the invention will be described in conjunction with the illustrated embodiment, it will be understood that it is not intended to limit the invention to such embodiment. On the contrary, it is intended to cover all alternatives, modifications and equivalents as may be included within the spirit and scope of the invention as defined.

The term “heart aid ingredients” as used in the specification shall include ingredients having properties which result in maintaining a healthy heart for an individual.

### DETAILED DESCRIPTION OF THE INVENTION

The embodiments of the present invention will now be described in detail with reference to the accompanying drawings. However, the present invention is not limited to the embodiments. The present invention can be modified in various forms. Thus, the embodiments of the present invention are only provided to explain more clearly the present invention to the ordinarily skilled in the art of the present invention.

The present invention claims a beverage having heart aid ingredients and a process of manufacturing it, which includes the steps of purification of water, mixing of ingredients, blending, homogenization and pasteurization of the beverage at specific process conditions.

In one embodiment, the invention can be worked by making a carbonated or non-carbonated beverage.

In yet another embodiment, the invention can be worked by using different forms of sweetening agents, which include but are not limited to low sugar variants present in the market, agents which make the final product sweet but do not add to the calories to the product and others, so that the level of sugar in the whole finished product can be marginalized.

In yet another embodiment, natural or synthetic sweetening agents can be used.

In yet another embodiment, the percentage of sweetening agent in the beverage can be reduced or increased based on the need of the recipients, which includes but is not limited to use of less percentage of sugar in the whole concentrate.

In yet another embodiment, natural or synthetic flavours, which include but are not limited to flavours having preservative characteristics and others, can be used to tag aroma to the final product.

In yet another embodiment, natural or synthetic food colours can be used.

In yet another embodiment, any holding vessel or container can be used for filling the final product, which include but are not limited to sachets, bottles, tetra packs and others.

In yet another embodiment, any mode of cooling the final product, which includes but are not limited to the modes of direct and indirect cooling and others, can be used for marking the culmination of the process, claimed in the invention.

In one of the preferred embodiment, the ready to drink beverage contains processed water, fructose powder, fruit juices from concentrate, grape seed extract, natural fruit sweetener, acidity regulators, natural flavours, emulsifiers, antioxidants, natural food colour.

In one of the preferred embodiment, the beverage with heart aid function ingredients comprises:
80 to 90% potable water,
2.5 to 6% fructose powder,
0.1 to 15% fruit puree/juices from concentrate,
1 to 6% fruit sweetener,
0.01 to 0.2% grape seed extract,
0.01 to 0.3% fruit flavours,
0.01 to 0.3% acidity regulators,
0.01 to 0.5% stabilizers and emulsifiers,
0.01 to 0.2% antioxidants,
0.001 to 0.02% food colour.

In yet another embodiment, the beverage with heart aid function ingredients with orange mango flavour comprises:
80 to 85% potable water,
3.5 to 5.5% fructose powder,
3.5 to 5.5% fruit sweetener,
3.5 to 5.5% Mango Puree from concentrate
2 to 5% Orange juice from concentrate,
0.5 to 1.5% Mango puree,
0.05 to 0.4% stabilizers and emulsifiers,
0.01 to 0.1% grape seed extract,
0.01 to 0.3% fruit flavours,
0.05 to 0.3% acidity regulators,
0.01 to 0.05% antioxidants,
0.001 to 0.02% food colour.

In yet another embodiment, the beverage with heart aid function ingredients with multi-fruit flavour comprises:
80 to 90% potable water,
3.5 to 5.5% fructose powder,
1.5 to 4.5% Blood orange juice from concentrate
0.1 to 3% Mandarin juice from concentrate,
0.1 to 2% Guava juice from concentrate,
0.1 to 2% Apple juice from concentrate,
1.5 to 3.5% fruit sweetener,
0.05 to 0.5% stabilizers and emulsifiers,
0.01 to 0.2% grape seed extract,
0.01 to 0.3% fruit flavours,
0.05 to 0.3% acidity regulators,
0.01 to 0.05% antioxidants,
0.001 to 0.02% food colour.

In yet another embodiment, the beverage with heart aid function ingredients with Orange-mandarin flavour comprises:
80 to 90% potable water,
2.5 to 5.5% fructose powder,
2.5 to 5.5% fruit sweetener,
1 to 5% Orange juice from concentrate,
1 to 4% Mandarin juice from concentrate,
0.01 to 0.4% stabilizers and emulsifiers,
0.01 to 0.2% grape seed extract,
0.01 to 0.3% fruit flavours,
0.01 to 0.3% acidity regulators,
0.01 to 0.2% antioxidants,
0.001 to 0.02% food colour.

In yet another embodiment, the beverage with heart aid function ingredients with Orange-Mandarin flavour comprises:
80 to 90% potable water,
3 to 6% fructose powder,
1 to 5% fruit sweetener,
1 to 5% Orange juice from concentrate,
1 to 4% Pineapple juice from concentrate,
1 to 4% Guava juice from concentrate,
0.01 to 0.4% stabilizers and emulsifiers,
0.01 to 0.2% grape seed extract,
0.01 to 0.3% fruit flavours,
0.01 to 0.3% acidity regulators,
0.01 to 0.2% antioxidants,
0.001 to 0.02% food colour.

Alternate ingredients stand alone or in combination and are fruit juices, vegetable juices, herbs and their extracts, spices and their extracts, dairy products such as milk (from cow, buffalo, goat), soya milk and groundnut milk etc and such other ingredients which can form part of the embodiment.

The fruits juices may be selected from the group consisting of:
a. Citrus like limes, mandarins, grapefruit, oranges and lemons.
b. Tropical fruits like bananas and mangoes.
c. Stone fruit (also called tree fruit) such as plums, peaches, nectarines and apricots.
d. Berries like strawberries, kiwifruit and blueberries
e. Melons: rock melons, honey dew melons and watermelons.
f. Tomatoes, Oilives and avocados are also fruits and each represents a category type.
g. Fruits with no seeds, one-stoned fruit (e.g—Dates), segmented fruits (e.g.—jackfruit), two-seeded fruits up to fruits containing 10 seeds (e.g.—star fruit) and fruits containing more than 15 seeds (e.g.—Guava, Kiwi, Passion fruit, Pomegranate, Apple, etc).

The fruits juices may be selected from the group consisting of: marrow (e.g.—Cucumber, Pumpkin and Zucchini); roots (e.g.—Potato, Yam and Sweet potato); Cruciferous (e.g.—Cabbage, Broccoli, Cauliflower); Leafy green (e.g.—Lettuce, Silver beet and Spinach); Edible plant stem (e.g.—Asparagus and Celery) and Allium (e.g.—Onion, Shallot and Garlic.), Herbs and their extracts and Spices and their extracts.

The Vegetable juices may be selected from the group consisting of:
1. Leafy green vegetables, root vegetables (e.g.—Beets, Carrots and Turnips),
2. Stalk vegetables (e.g.—Chard, Fennel and Kohlrabi),
3. Bulb vegetables (e.g.—Garlic, Onion, Cives and Leek),
4. Tuber vegetables (e.g.—Taro, Yam and Cassava) and
5. Inflorescent vegetables (e.g.—Artichokes, Cauliflower, Broccoli rabe and Broccoli.)
   Also group comprising of the fruit vegetables juices e.g. Olives, Squash, Avocados, Cucumbers, Peppers, Tomatoes, Tomatillos, Okra, Chayote and Eggplant.

The beverage can be formulated in different flavours and combinations. Following formulations have been developed and provide a categorization of different ingredients in the claimed beverage:

### a) Formulation Mango-Orange:

| | | Most | |
|---|---|---|---|
| | Preferred | Preferred | |
| Composition | range (%) | range (%) | Ingredient Function |
| Treated/ | 80 to 85 | 82 to 83 | Hydration and |
| Processed | | | replenishment of |
| water | | | water in human body |
| Fructose powder | 3.5 to 5.5 | 4.5 to 4.7 | Sweetener and taste |
| Natural Fruit | 3.5 to 5.5 | 4.1 to 4.3 | Sweetener and taste |
| Sweetener | | | |
| Mango Puree | 3.5 to 5.5 | 4.0 to 4.2 | Taste and flavour |
| from concentrate | | | |
| Orange juice | 2 to 5 | 2.8 to 3.2 | Taste and flavour |
| from concentrate | | | |
| Mango puree | 0.5 to 1.5 | 0.75 to 1.2 | Taste and flavour |
| Stabilizer - | 0.05 to 0.4 | 0.15 to 0.3 | Stabilizer, anti |
| Pectin | | | settling agent and |
| | | | to give mouth feel |
| Citric acid | 0.05 to 0.3 | 0.08 to 0.15 | Acidulant- to give |
| | | | sourness to the |
| | | | beverage |
| Grape seed | 0.01 to 0.1 | 0.04 to 0.08 | For good heart health |
| extract | | | and blood circulatory |
| | | | system |
| Antioxidant | 0.01 to 0.05 | 0.02 to 0.04 | Antioxidant- source of |
| (ascorbic | | | Vitamin C and avoids |
| acid) | | | degradation of beverage |
| | | | due to oxidation. |
| Natural | 0.01 to 0.3 | 0.08 to 0.15 | Flavouring agent- for |
| flavours | | | taste and flavour |
| Food colour | 0.001 to 0.02 | 0.001 to 0.01 | Colourant- imparts |
| Beta-carotene | | | colour to the final |
| E | | | beverage and improves |
| | | | aesthetics. |

### b) Formulation Multi-Fruit:

| | | Most | |
|---|---|---|---|
| | Preferred | Preferred | |
| Composition | range (%) | range (%) | Ingredient Function |
| Treated/ | 80 to 90 | 86 to 87 | Hydration and |
| Processed | | | replenishment of |
| water | | | water in human body |
| Fructose powder | 3.5 to 5.5 | 5.0 to 5.6 | Sweetener and taste |
| Blood Orange | 1.5 to 4.5 | 2.8 to 3.2 | Taste and flavour |
| juice from | | | |
| concentrate | | | |
| Natural Fruit | 1.5 to 3.5 | 2.6 to 3.0 | Sweetener and taste |
| Sweetener | | | |
| Mandarin juice | 0.1 to 3 | 0.5 to 1.5 | Taste and flavour |
| from concentrate | | | |
| Guava juice | 0.1 to 2 | 0.4 to 0.6 | Taste and flavour |
| from concentrate | | | |
| Apple juice | 0.1 to 2 | 0.4 to 0.6 | Taste and flavour |
| from Concentrate | | | |
| Stabilizer - | 0.05 to 0.5 | 0.22 to 0.26 | Stabilizer, anti |
| Pectin | | | settling agent and |
| | | | to give mouth feel |
| Citric acid | 0.05 to 0.3 | 0.08 to 0.15 | Acidulant - to give |
| | | | sourness to the |
| | | | beverage |
| Grape seed | 0.01 to 0.2 | 0.04 to 0.08 | For good heart health |
| extract | | | and blood circulatory |
| | | | system |
| Antioxidant | 0.01 to 0.05 | 0.02 to 0.04 | Antioxidant- source of |
| (ascorbic | | | Vitamin C and avoids |
| acid) | | | degradation of beverage |
| | | | due to oxidation. |
| Natural flavours | 0.01 to 0.3 | 0.08 to 0.15 | Flavouring agent- for |
| | | | taste and flavour |
| Food colour | 0.001 to 0.02 | 0.001 to 0.01 | Colourant- imparts |
| beta-apo-8′- | | | colour to the final |
| carotenal | | | beverage and improves |
| | | | aesthetics'. |

### c) Formulation Orange-Mandarin:

| | | Most | |
|---|---|---|---|
| | Preferred | Preferred | |
| Composition | range (%) | range (%) | Ingredient Function |
| Treated/ | 80 to 90 | 85 to 87 | Hydration and |
| Processed | | | replenishment of |
| water | | | water in human body |
| Fructose powder | 2.5 to 5.5 | 4.0 to 5.0 | Sweetener and taste |
| Natural Fruit | 2.5 to 5.5 | 3.6 to 3.8 | Sweetener and taste |
| Sweetener | | | |
| Orange juice | 1 to 5 | 2.7 to 3.3 | Taste and flavour |
| from concentrate | | | |
| Mandarin juice | 1 to 4 | 1.8 to 2.6 | Taste and flavour |
| from concentrate | | | |
| Stabilizer - | 0.01 to 0.4 | 0.18 to 0.24 | Stabilizer, anti |
| Pectin | | | settling agent and |
| | | | to give mouth feel |
| Citric acid | 0.01 to 0.3 | 0.08 to 0.15 | Acidulant - to give |
| | | | sourness to the |
| | | | beverage |
| Natural | 0.01 to 0.3 | 0.08 to 0.15 | Flavouring agent- |
| flavours | | | for taste and flavour |
| Grape seed | 0.01 to 0.2 | 0.04 to 0.08 | For good heart health |
| extract | | | and blood circulatory |
| | | | system |
| Antioxidant | 0.01 to 0.2 | 0.02 to 0.04 | Antioxidant- source of |
| (ascorbic | | | Vitamin C and avoids |
| acid) | | | degradation of beverage |
| | | | due to oxidation. |
| Food colour | 0.001 to 0.02 | 0.001 to 0.01 | Colourant- imparts |
| Beta-carotene | | | colour to the final |
| E | | | beverage and improves |
| | | | aesthetics. |

### d) Formulation Orange-Pineapple-Guava:

| | | Most | |
|---|---|---|---|
| | Preferred | Preferred | |
| Composition | range (%) | range (%) | Ingredient Function |
| Treated/ | 80 to 90 | 84 to 88 | Hydration and |
| Processed | | | replenishment of |
| water | | | water in human body |
| Fructose powder | 3 to 6 | 4.4 to 4.8 | Sweetener and taste |
| Orange juice | 1 to 5 | 2.7 to 3.2 | Taste and flavour |
| from concentrate | | | |
| Natural Fruit | 1 to 5 | 2.7 to 3.2 | Sweetener and taste |
| Sweetner | | | |
| Pineapple juice | 1 to 4 | 1.3 to 1.7 | Taste and flavour |
| from concentrate | | | |
| Guava juice | 1 to 4 | 1.3 to 1.7 | Taste and flavour |
| from concentrate | | | |
| Stabiliser - | 0.01 to 0.4 | 0.18 to 0.24 | Stabilizer, anti |
| Pectin | | | settling agent and |
| | | | to give mouth feel |
| Citric acid | 0.01 to 0.3 | 0.08 to 0.15 | Acidulant- to give |
| | | | sourness to the |
| | | | beverage |
| Grape seed | 0.01 to 0.2 | 0.04 to 0.08 | For good heart health |
| extract | | | and blood circulatory |
| | | | system |
| Antioxidant | 0.01 to 0.2 | 0.02 to 0.04 | Antioxidant- source |
| (ascorbic | | | of Vitamin C and avoids |
| acid) | | | degradation of beverage |
| | | | due to oxidation. |
| Natural | 0.01 to 0.3 | 0.08 to 0.15 | Flavouring agent- for |
| flavours | | | taste and flavour |
| Food colour | 0.001 to 0.02 | 0.001 to 0.01 | Colourant- imparts |
| Beta-carotene | | | colour to the final |
| E | | | beverage and improves |
| | | | aesthetics. |

In yet another preferred embodiment, the process steps employed include the steps of purification of water, mixing of ingredients, blending, homogenization and pasteurization of the beverage at carried at temperature range of 90 to 97 degree Celsius.

Although the invention of process and product has been described in connection with the embodiment of the present invention, illustrated in the accompanying drawings, it is not limited thereto. It will be apparent to those skilled in the art that various substitutions, modifications and changes may be made thereto without departing from the scope and spirit of the invention. The invention as described herein above partakes the essence of different steps enumerated supra and is not limited to the subjective wording of terms used herein.

In one of the preferred embodiment, the process involves measurement and transfer of about 3 to 10% of total beverage water (treated/potable water) into a stainless steel mixing tank.

In one of the preferred embodiment, the process involves measurement and transfer of about 3 to 10% of total beverage water (treated/processed water) into a stainless steel mixing tank. Adding to it 1% to 6% of natural fruit sweetener. This is followed by dissolution at about 2.5% to 6% of total fructose powder, in about 20% to 25% of total beverage water (treated/processed water) at 40 to 50 degree Celsius and transferring the same to a beverage blending tank. Pectin solution (1%) is prepared in a separate mixing tank by dispersing 2.2% to 2.5% of pectin in 25% of total beverage water at 60 to 70 deg C. This solution is then taken to the main mixing tank. In the beverage tank, 0.06% to 0.13% of citric acid monohydrate is further mixed in approximately 0.5% to 1% of total beverage water. Add fruit puree and/or fruit concentrate in the range of 0 to 15% and agitate until completely mixed. This is followed by dissolution of 0.05% to 0.06% of grape seed extract in approximately 6.5% to 7% of total beverage water at 60 to 70 degree Celsius. Addition of 1.2% to 1.6% of the Flavour compound takes place thereafter to the blend in the beverage tank. Flavour compound is a blend of all the ingredients including fruit juice concentrate, natural flavour, stabilizers and food colours. This is followed by dissolution of 0.02% to 0.04% of ascorbic acid in 0.2% to 0.5% of total beverage water. Add the remaining portion of total beverage water and mix thoroughly; the beverage formed is final beverage. Final beverage is then homogenized using a homogenizer and is carried out at a pressure of 100 bar. This is followed by pasteurization of the final beverage in tubular heat exchanger or plate heat exchanger at 90 to 97 degree Celsius, with a holding time of 30 to 180 seconds in the holding tube. Pasteurized beverage is then cooled to 83 to 87 degree Celsius and filled.

The invention will now be explained with the help of following examples. However, the scope of the invention should not be limited to these examples as the person skilled in the art can easily vary the proportion of the ingredients and combinations.

### Example 1

### Preparing the Orange Mandarin Beverage

Taking the ingredients in following quantity:

| Composition | Quantity (g/l) |
|---|---|
| Treated/Processed water | 907 |
| Fructose powder | 44.5 |
| Natural Fruit Sweetener | 40 |
| Mandarin juice from concentrate | 21 |
| Orange juice from concentrate | 31.5 |
| Stabilizer Pectin | 2.5 |
| Citric acid | 1.0 |
| Grape seed extract | 0.6 |
| Antioxidant (ascorbic acid) | 0.3 |
| Natural flavours | <1 |
| Food colour Beta-carotene E | <0.1 |

Preparing the beverage as per the process such as herein described.

### Example 2

### Preparing the Orange-Pineapple-Guava Beverage

Taking the ingredients in following quantity:

| Composition | Quantity (g/l) |
|---|---|
| Treated/Processed water | 903 |
| Fructose powder | 48.7 |
| Natural Fruit Sweetener | 30 |
| Pineapple juice from concentrate | 15.75 |
| Orange juice from concentrate | 31.5 |
| Guava juice from concentrate | 15.75 |
| Stabilizer Pectin | 2.54 |
| Citric acid | 1.37 |
| Grape seed extract | 0.6 |
| Antioxidant (ascorbic acid) | 0.32 |
| Natural flavours | <1 |
| Food colour Beta-carotene E | <0.1 |

Preparing the beverage as per the process such as herein described.

### Example 3

### Preparing the Multi-Fruit Beverage

Taking the ingredients in following quantity:

| Composition | Quantity (g/l) |
|---|---|
| Treated/Processed water | 906 |
| Fructose powder | 55.5 |
| Natural Fruit Sweetener | 30 |
| Blood Orange juice from concentrate | 31.5 |
| Mandarin juice from concentrate | 10.5 |
| Apple juice from concentrate | 5.25 |
| Guava juice from concentrate | 5.25 |
| Stabilizer Pectin | 2.53 |
| Citric acid | 1.40 |
| Grape seed extract | 0.6 |
| Antioxidant (ascorbic acid) | 0.32 |
| Natural flavours | <1 |
| Food colour Beta-carotene E | <0.1 |

Preparing the beverage as per the process such as herein described.

### Example 4

### Preparing the Mango Orange Beverage

Taking the ingredients in following quantity:

| Composition | Quantity (g/l) |
|---|---|
| Treated/Processed water | 868 |
| Fructose powder | 48.7 |
| Natural Fruit Sweetener | 44 |
| Mango juice from concentrate | 42.74 |
| Orange juice from concentrate | 31.5 |
| Mango Puree | 10.29 |
| Stabilizer Pectin | 2.5 |
| Citric acid | 1.3 |
| Grape seed extract | 0.6 |
| Antioxidant (ascorbic acid) | 0.31 |
| Natural flavours | <1 |
| Food colour Beta-carotene E | <1 |

Preparing the beverage as per the process such as herein described.

1. A beverage with heart aid function ingredients comprising:
80 to 90% potable water,
2.5 to 6% fructose powder,
0.1 to 15% fruit puree/juices from concentrate,
1 to 6% fruit sweetener,
0.01 to 0.2% grape seed extract,
0.01 to 0.3% fruit flavours,
0.01 to 0.3% acidity regulators,
0.01 to 0.5% stabilizers and emulsifiers,
0.01 to 0.2% antioxidants,
0.001 to 0.02% food colour.

2. The beverage with heart aid function ingredients as claimed in claim 1, wherein the orange mango beverage comprises:
80 to 85% potable water,
3.5 to 5.5% fructose powder,
3.5 to 5.5% fruit sweetener,
3.5 to 5.5% Mango Puree from concentrate,
2 to 5% Orange juice from concentrate,
0.5 to 1.5% Mango puree,
0.05 to 0.4% stabilizers and emulsifiers,
0.01 to 0.1% grape seed extract,
0.01 to 0.3% fruit flavours,
0.05 to 0.3% acidity regulators,
0.01 to 0.05% antioxidants,
0.001 to 0.02% food colour.

3. The beverage with heart aid function ingredients as claimed in claim 1, wherein the multi-fruit beverage comprises:
80 to 90% potable water,
3.5 to 5.5% fructose powder,
1.5 to 4.5% Blood orange juice from concentrate
0.1 to 3% Mandarin juice from concentrate,
0.1 to 2% Guava juice from concentrate,
0.1 to 2% Apple juice from concentrate,
1.5 to 3.5% fruit sweetener,
0.05 to 0.5% stabilizers and emulsifiers,
0.01 to 0.2% grape seed extract,
0.01 to 0.3% fruit flavours,
0.05 to 0.3% acidity regulators,
0.01 to 0.05% antioxidants,
0.001 to 0.02% food colour.

4. The beverage with heart aid function ingredients as claimed in claim 1, wherein the Orange-mandarin beverage comprises:
80 to 90% potable water,
2.5 to 5.5% fructose powder,
2.5 to 5.5% fruit sweetener,
1 to 5% Orange juice from concentrate,
1 to 4% Mandarin juice from concentrate,
0.01 to 0.4% stabilizers and emulsifiers,
0.01 to 0.2% grape seed extract,
0.01 to 0.3% fruit flavours,
0.01 to 0.3% acidity regulators,
0.01 to 0.2% antioxidants,
0.001 to 0.02% food colour.

5. The beverage with heart aid function ingredients as claimed in claim 1, wherein the Orange-mandarin beverage comprises:
80 to 90% potable water,
3 to 6% fructose powder,
1 to 5% fruit sweetener,
1 to 5% Orange juice from concentrate,
1 to 4% Pineapple juice from concentrate,
1 to 4% Guava juice from concentrate,
0.01 to 0.4% stabilizers and emulsifiers,
0.01 to 0.2% grape seed extract,
0.01 to 0.3% fruit flavours,
0.01 to 0.3% acidity regulators,
0.01 to 0.2% antioxidants,
0.001 to 0.02% food colour.

6. The beverage with heart aid function ingredients as claimed in claim 1, wherein the beverage may be carbonated or non-carbonated.

7. The beverage with heart aid function ingredients as claimed in claim 1, wherein the sweetener may be natural or synthetic.

8. The beverage with heart aid function ingredients as claimed in claim 1, wherein the fruit flavours may be natural or synthetic.

9. The beverage with heart aid function ingredients as claimed in claim 1, wherein the food colour may be natural or synthetic.

10. The beverage with heart aid function ingredients as claimed in claim 1, wherein the beverage can be stored in containers selected from sachets, bottles, tetra packs and others.

11. The beverage with heart aid function ingredients as claimed in claim 1, wherein the juices either stand alone or in combination may be selected from the group comprising fruit juices, vegetable juices, herbs and their extracts, spices and their extracts, dairy products such as animal milk, soya milk and groundnut milk etc.

12. The beverage with heart aid function ingredients as claimed in claim 1, wherein the fruits juices may be selected from the group consisting of:
a. Citrus selected from limes, mandarins, grapefruit, oranges and lemons;
b. Tropical fruits selected from bananas and mangoes;
c. Stone fruit (also called tree fruit) selected from plums, peaches, nectarines and apricots;
d. Berries selected from strawberries, kiwifruit and blueberries;
e. Melons selected from rock melons, honey dew melons and watermelons;
f. Tomatoes, Oilives and avocados;
g. Fruits with no seeds, one-stoned fruit (e.g Dates), segmented fruits (e.g. jackfruit), two-seeded fruits up to fruits containing 10 seeds (e.g. star fruit) and fruits containing more than 15 seeds (e.g. Guava, Kiwi, Passion fruit, Pomegranate, Apple, etc).
h. marrow (e.g. Cucumber, Pumpkin and Zucchini); roots (e.g. Potato, Yam and Sweet potato); Cruciferous (e.g. Cabbage, Broccoli, Cauliflower); Leafy green (e.g. Lettuce, Silver beet and Spinach); Edible plant stem (e.g. Asparagus and Celery) and Allium (e.g. Onion, Shallot and Garlic.), Herbs and their extracts and Spices and their extracts.

13. The beverage with heart aid function ingredients as claimed in claim 1, wherein the vegetable juices may be selected from the group consisting of:
a. leafy green vegetables, root vegetables (e.g. Beets, Carrots and Turnips);
b. stalk vegetables (e.g. Chard, Fennel and Kohlrabi);
c. bulb vegetables (e.g. Garlic, Onion, Cives and Leek);
d. tuber vegetables (e.g. Taro, Yam and Cassava);
e. inflorescent vegetables (e.g. Artichokes, Cauliflower, Broccoli rabe and Broccoli);
f. fruit vegetables juices (e.g. Olives, Squash, Avocados, Cucumbers, Peppers, Tomatoes, Tomatillos, Okra, Chayote and Eggplant);

14. A process of preparing beverage with heart aid function ingredients comprising the steps of:
purification of water,
mixing of ingredients,
blending, homogenization and pasteurization of the beverage at temperature range of 90 to 97 degree Celsius.

15. The process as claimed in claim 14, wherein the process steps comprise:
measurement and transfer of about 3 to 10% of total beverage water (treated/potable water) into a stainless steel mixing tank;
adding 1% to 6% of natural fruit sweetener to said water in mixing tank;
dissolving about 2.5% to 6% of total fructose powder, in about 20% to 25% of total beverage water (treated/potable water) at 40 to 50 degree Celsius and transferring the same to a beverage blending tank;
preparing 1% stabilizer (pectin) solution in a separate mixing tank by dispersing said stabilizer in 25% of total beverage water at 60 to 70 deg C; and transferring said solution is then taken to the main mixing tank;
mixing in the beverage tank, 0.06% to 0.13% of acidity regulator (citric acid monohydrate) in approximately 0.5% to 1% of total beverage water.
adding fruit puree and/or fruit concentrate in the range of 0 to 15% and agitating the same until completely mixed followed by dissolution of 0.05% to 0.06% of grape seed extract in approximately 6.5% to 7% of total beverage water at 60 to 70 degree Celsius;
adding 1.2% to 1.6% of the flavour compound to the blend in the beverage tank; wherein the favour compound is a blend of all the ingredients including fruit juice concentrate, natural flavour, stabilizers and food colours.
subsequently dissolution of ascorbic acid in 0.2% to 0.5% of total beverage water;
adding the remaining portion of total beverage water and mix thoroughly; the beverage formed is final beverage;
homogenizing the final beverage using a homogenizer at a pressure of 100 bar followed by pasteurization of the final beverage in tubular heat exchanger or plate heat exchanger at 90 to 97 degree Celsius, with a holding time of 30 to 180 seconds in the holding tube;
cooling the pasteurized beverage to 83 to 87 degree Celsius and filling the same in the desirable containers.

16. The beverage with heart aid function ingredients of claim 10, wherein the flavor compound is a blend of all the ingredients including fruit juice concentrate, natural flavor, stabilizers and food colours.

17. (canceled)

18. (canceled)
